(19) United States
(12) Patent Application Publication
(10) Pub. No.: US 2013/0315112 A1
(43) Pub. Date: Nov. 28, 2013

(54) SYSTEM AND METHODS FOR CELLULAR/SATELLITE NETWORK COEXISTENCE

(71) Applicant: Eden Rock Communications, LLC, Bothell, WA (US)

(72) Inventors: Eamonn GORMLEY, Bothell, WA (US); Chaz IMMENDORF, Bothell, WA (US)

(21) Appl. No.: 13/902,746

(22) Filed: May 24, 2013

Related U.S. Application Data
(60) Provisional application No. 61/651,570, filed on May 25, 2012.

(51) Int. Cl. H04W 16/14

(52) U.S. Cl. CPC H04W 16/14
USPC 370/280; 370/317

(57) ABSTRACT

A method for satellite and cellular network coexistence includes dividing a predetermined time period into a plurality of time slots, designating a first time as an active communication time for at least one antenna of a first base station, designating a second time slot as a silent time for the least one antenna, initiating RF transmissions from the at least one antenna and cellular devices attached to the at least one antenna during the first time slot, and terminating the RF transmissions from the at least one antenna and cellular devices attached to the at least one antenna prior to the start of the second time slot, wherein the at least one antenna does not transmit RF signals for the duration of the second time slot.

### CROSS-REFERENCES TO RELATED APPLICATIONS

The present invention claims priority to and is a non-provisional of U.S. Application No. 61/651,570, filed May 25, 2012. That application is herein incorporated by reference for all purposes.

### BACKGROUND OF THE INVENTION

This document describes a system and methods for operating a terrestrial cellular wireless network in the same frequency band or an adjacent frequency band to a satellite wireless network.

FIG. 1 shows a terrestrial (ground based) cellular wireless network which includes a plurality of base stations 102a-d, mobile devices 104a-d, core network elements 106 and a data communications network 108 over which the base stations 102 can communicate with the core network elements 106 and optionally with each other. The cellular wireless network may be a standards-based network using a standard such as GSM, UMTS, LTE, WiMAX, WiFi or other such standards, or the cellular network may be based on a proprietary design.

FIG. 1 also shows a satellite communications network including orbiting satellites 110a and 110b and ground based satellite receivers 108a-c. Well known examples of satellite communications networks include the Global Positioning System (GPS), the Global Navigation Satellite System (GLONASS), the Galileo navigation system, Satellite television systems, etc. The ground based satellite receivers 108 may optionally be capable of transmitting data to the orbiting satellites 110.

The radio signals from the orbiting satellites 110 are typically relatively low power by the time they arrive at the ground based satellite receivers 108. The ground based satellite receivers 108 generally use relatively sensitive radio frequency (RF) receivers in order to receive the radio signals from the orbiting satellites 110.

In many cases, the RF transmissions from the cellular network, which is a terrestrial network, can cause reception problems for the ground based satellite receivers. There are several ways in which reception problems can occur between terrestrial and satellite communications.

First, systems can experience co-channel interference. If the satellite network and the cellular network operate on the same frequency bands then the cellular network RF transmissions cause co-channel interference to the ground based satellite receivers. Interference levels are inversely proportional to the physical distance between ground based satellite receivers and transmitters in the terrestrial cellular network. In FIG. 1, base stations 102 and mobile devices 104 are transmitters.

Second, systems can experience adjacent channel interference. Even though the cellular network may not nominally transmit on the same frequencies used by the ground based satellite receivers, the cellular network may also have unwanted RF emissions on the frequencies used by the satellite network. Adjacent channel interference is most likely when the cellular network and the satellite network operate on nearby or adjacent frequencies.

Third, systems can experience receiver overload. Even if the cellular network does not have any unwanted emissions on the frequencies used by the ground based satellite receivers, if the satellite receiver has poor channel selectivity, then the cellular network signals it receives can overload the receiver front end.

Existing techniques can be used to reduce the severity of the reception problems for the ground based satellite receivers. However, these techniques are not without their own drawbacks. The following passages describe some of these techniques and the drawbacks associated with them.

One technique is to increase the distance between transmitters in a cellular network and ground based satellite receivers. However, it is not always feasible to enforce an increased distance, especially for user equipment. Mobile ground based satellite receivers may move closer to cellular base stations, where the severity of reception problems increase. In addition, mobile devices in a cellular network may move closer to ground based satellite receivers, increasing the severity of the reception problems.

Another technique is to reduce transmit power on cellular network transmitters. However, this decreases the performance of the cellular network.

Another technique is to increase the frequency separation between cellular and satellite networks. However, it is not always feasible to increase the frequency separation. Separated frequencies can still cause receiver blocking problems, particularly for ground based satellite receivers that have poor selectivity. In addition, spectrum inefficiencies occur due to the presence of unused guard bands between the two systems.

Another technique is to increase the selectivity of ground based satellite receivers by adding filters to the ground based satellite receivers. However, it may not be practical or possible to retrofit every satellite receiver, especially in mass produced legacy devices. In addition, filters can also cause additional signal losses in their passbands, degrading the performance of the satellite receivers.

Still another technique is to install directional antennas on satellite receivers. However, this may not be feasible for mobile ground based satellite receivers such as handheld GPS navigation devices.

### BRIEF SUMMARY OF THE INVENTION

Embodiments of the present invention facilitate cellular and satellite co-existence. Communication times are divided between active times and quiet times in nearby, adjacent or overlapping frequencies. Various terrestrial RF transmissions may cease for the duration of the quiet times to allow ground-based satellite receivers to receive satellite transmissions with reduced levels of interference.

In an embodiment, a system for coordinating terrestrial and satellite radio frequency (RF) communications comprises a processor and a non-transient computer readable medium with computer executable instructions stored thereon which, when executed by the processor, divides a predetermined time period into a plurality of time slots, designates a first time slot from among the plurality of divided time slots as an active communication time for at least one antenna of a first base station, designates a second time slot from among the plurality of divided time slots as a silent time for the least one antenna of the first base station, initiates RF transmissions from the at least one antenna of the first base station, cellular devices attached to the at least one antenna of the first base station, or a combination thereof during the first time slot, and terminates the RF transmissions from the at least one antenna of the first base station, cellular devices attached to the at least one antenna of the first base station, or a combination thereof prior to the start of the second time slot. The at least one antenna of the first base station may not transmit RF signals for the duration of the second time slot.

In an embodiment, a portion of the RF spectrum used for the transmissions from the at least one antenna of the first base station is adjacent to a portion of the RF spectrum allocated for satellite transmissions. In another embodiment, a portion of the RF spectrum used for the transmissions from the at least one antenna of the first base station overlaps with a portion of the RF spectrum allocated for satellite transmissions.

In an embodiment, the predetermined time period is divided into a plurality of the first time slots and a plurality of the second time slots, each of the first time slots alternating with each of the second time slots. Each of the first time slots may be divided into at least one third time slot and at least one fourth time slot according to a time division duplexing (TDD) scheme.

In an embodiment the executed instructions designate a third time slot from among the plurality of divided time slots, the first, second, and third time slots occurring in consecutive order, allocating the first time slot to a first antenna attached to the first base station, allocate the second time slot to a second antenna attached to the first base station, and allocate the third time slot to a third antenna attached to the first base station. Each of first, second, and third antennas may transmit RF signals during the time slots to which they are allocated, and do not transmit RF signals during the time slots to which they are not allocated.

In another embodiment the executed instructions designate a third time slot from among the plurality of divided time slots, the first, second, and third time slots occurring in consecutive order, allocate the first time slot to the first base station, allocate the second time slot to a second base station, and allocate the third time slot to a third base station. Each of first, second, and third base stations may transmit RF signals during the time slots to which they are allocated, and may not transmit RF signals during the time slots to which they are not allocated.

In an embodiment, each of a predetermined set of antennas ceases RF transmissions for the duration of the second time slot. In another embodiment, the predetermined set of antennas is selected based on a relationship between the predetermined set of antennas and a ground-based satellite receiver.

In an embodiment in which base stations transmit using various power levels, no high power transmissions may occur during at least one time slot so that interference levels are reduced.

Various embodiments of the present invention may be implemented as a method, a system, or as instructions on a non-volatile computer readable medium. The scope of the present invention is not limited by the embodiments described herein; rather, the embodiments are provided and described in order to facilitate clear understanding through specific examples.

### BRIEF DESCRIPTION OF THE DRAWINGS

FIG. 1 illustrates a system diagram of satellite and cellular communications.

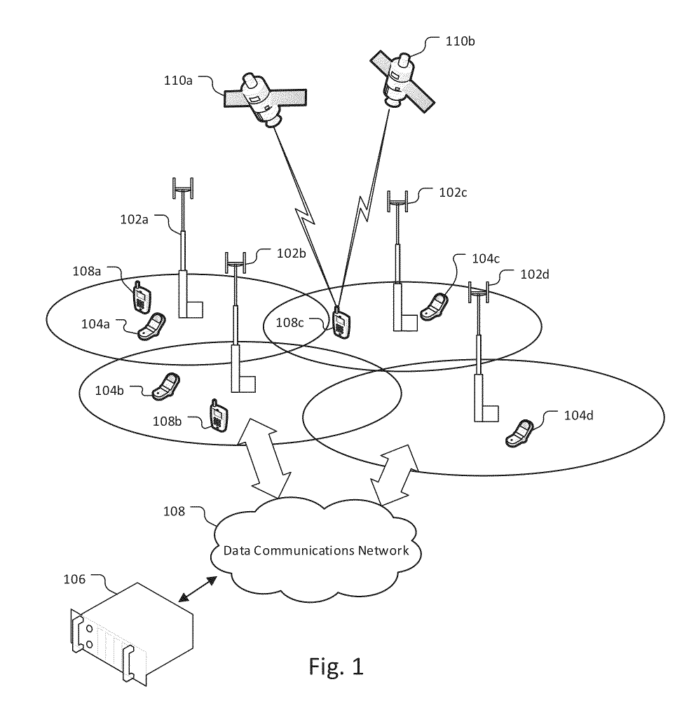

FIG. 2 illustrates a networked communications system according to an embodiment of the present invention.

FIG. 3 illustrates active transmission times and quiet times according to an embodiment of the present invention.

FIG. 4 illustrates time reuse according to an embodiment of the present invention.

FIG. 5 illustrates per-base station reuse according to an embodiment of the present invention.

FIG. 6 illustrates per-antenna reuse according to an embodiment of the present invention.

FIG. 7 illustrates a method for cellular and satellite co-existence according to an embodiment of the present invention.

FIG. 8 illustrates a satellite receiver according to an embodiment of the present invention.

### DETAILED DESCRIPTION OF THE INVENTION

Embodiments of the present invention include a system and methods for operating a cellular network in such a way that interference caused by the cellular network into the ground based satellite terminals is reduced or not present at all times. In an embodiment, the base stations and mobile terminals establish coordinated quiet times during which they do not transmit any signals. During these quiet times, the ground based satellite receivers can successfully receive the transmissions from orbiting satellites.

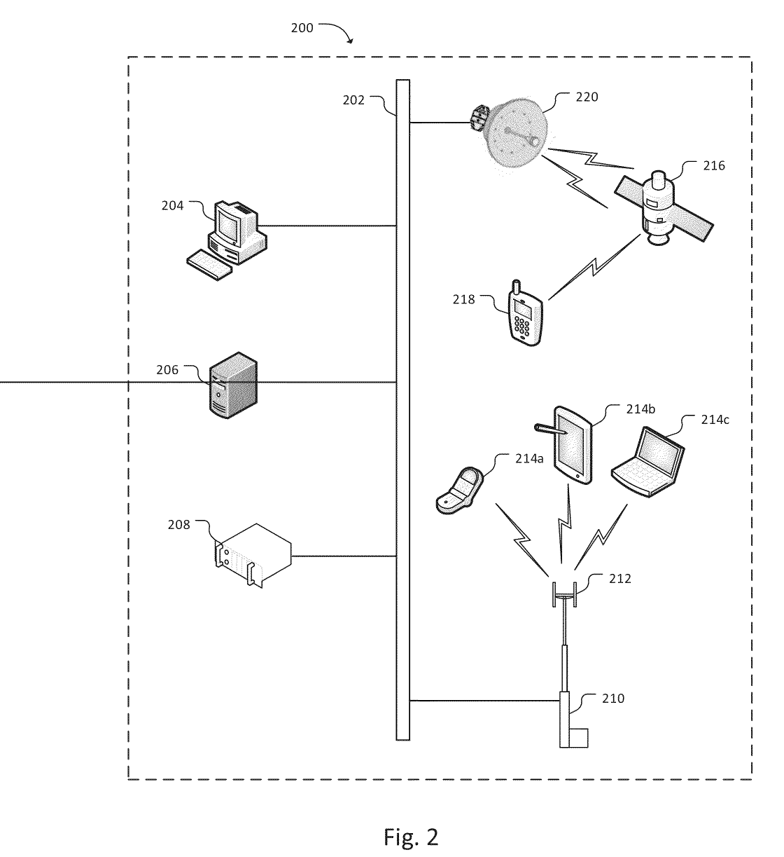

In accordance with an embodiment of the present invention, FIG. 2 illustrates a networked communications system 200 including various wired and wireless computing devices that may be utilized to implement processes associated with embodiments of the present invention.

A networked communications system 200 may include a group of service provider controller devices 204, 206, and 208, any of which may be Network Resource Controllers (NRCs) or have NRC functionality. The system may further included network base stations 210, any of which may be NRCs or have NRC functionality, and may share overlapping wireless coverage with one or more neighboring base stations within a particular region of the networked computing system 200. Each base station 210 may include one or more antenna 212 configured to transmit and receive RF signals.

A communications system 200 may further include a plurality of cellular devices 214. Cellular devices may be user equipment, and may include, for example, a cellular handheld communication device 214a such as a smartphone, a handheld tablet, reader, or gaming unit 214b and various portable computing devices 214c such as a laptop computer which are provided with wireless communications services from at least one base station 210. The network 202 includes a backhaul portion that can facilitate distributed network communications between any of the network controller devices 204, 206, and 208 and any of the network base stations 210.

As would be understood by those skilled in the Art, in most digital communications networks, the backhaul portion of a data communications network 202 may include intermediate links between a backbone of the network which are generally wireline, and sub networks or network base stations 212 located at the periphery of the network. For example, cellular user equipment (e.g., any of cellular devices 214a-c) communicating with one or more network base station 210 may constitute a local sub network. The network connection between any of the network base stations 210 and the rest of the world may initiate with a link to the backhaul portion of an access provider's communications network 202 (e.g., via a point of presence).

In some embodiments, the system 200 may further include a terrestrial transmitter 220 which is configured to communicate with one or more orbiting satellite 216. Satellite 216 may be any communications satellite, or part of a satellite navigation system such as GLONASS or GPS. The system may further include one or more satellite receiver 218 which receives RF transmissions from one or more satellite 216. In an embodiment, satellite receiver 218 may be incorporated into a cellular device 214. For example, a cellular telephone may be a cellular device 214 which includes a GPS module that is a satellite receiver 218. In other embodiments, satellite receiver 218 is dedicated to receiving and possibly transmitting RF signals with satellite 216, and does not have cellular communications capabilities.

A Network Resource Controller (NRC) is a physical entity that may include software components. An NRC may facilitate all or part of the wireless multisite capacity coordination processes associated with various embodiments of the present invention. In accordance with an embodiment of the present invention, an NRC that performs a particular coexistence process may be a physical device, such as a network controller device 204, 206, and 208 or a network base station 210. In yet another embodiment, an NRC that performs a particular wireless multisite capacity coordination process may be a logical software-based entity that can be stored in the volatile or non-volatile memory or memories, or more generally in a non-transitory computer readable medium, of a physical device such as a network controller device 204, 206, and 208, or a network base station 210.

In accordance with various embodiments of the present invention, the NRC has presence and functionality that may be defined by the processes it is capable of carrying out. Accordingly, the conceptual entity that is the NRC may be generally defined by its role in performing processes associated with various wireless multisite capacity coordination processes. Therefore, depending on the particular embodiment, the NRC entity may be considered to be either a physical device, and/or a software component that is stored in the computer readable media such as volatile or non-volatile memories of one or more communicating device(s) within a system 200.

In an embodiment, any of the service provider controller devices 204, 206, and 208, and/or network base stations 210 (optionally having NRC functionality or considered to be a NRC) may function independently or collaboratively to implement any of the processes associated with various embodiments of the present invention. Further, any of the interference mitigation processes may be carried out in accordance with any common communications technology known in the Art, such as those associated with modern Global Systems for Mobile (GSM), Universal Mobile Telecommunications System (UMTS), Long Term Evolution (LTE) network infrastructures, etc.

In accordance with a standard GSM network, any of the service provider controller devices 204, 206, and 208 (NRC devices or other devices optionally having NRC functionality) may be associated with a base station controller (BSC), a mobile switching center (MSC), or any other common service provider control device known in the art, such as a radio resource manager (RRM). In accordance with a standard UMTS network, any of the service provider controller devices 204, 206, and 208 (optionally having NRC functionality) may be associated with a network resource controller (NRC), a serving GPRS support node (SGSN), or any other common service provider controller device known in the art, such as a radio resource manager (RRM). In accordance with a standard LTE network, any of the service provider controller devices 204, 206, and 208 (optionally having NRC functionality) may be associated with an eNodeB base station, a mobility management entity (MME), or any other common service provider controller device known in the art, such as an RRM.

In an embodiment, any of the service provider controller devices 204, 206, and 208, the network base stations 210, as well as any of the cellular devices 214 and satellite receivers 218 may be configured to run any well-known operating system, including, but not limited to: Microsoft® Windows®, Mac OS®, Google® Chrome®, Linux®, Unix®, or any mobile operating system, including Symbian®, Palm®, Windows Mobile®, Google® Android®, Mobile Linux®, etc. In an embodiment, any of the service provider controller devices 204, 206, and 208, or any of the network base stations 210 may employ any number of common server, desktop, laptop, and personal computing devices.

In an embodiment, any of the cellular devices 214 may be associated with any combination of common mobile computing devices (e.g., laptop computers, netbook computers, tablet computers, cellular phones, PDAs, handheld gaming units, electronic book devices, personal music players, MiFi™ devices, video recorders, etc.), having wireless communications capabilities employing any common wireless data communications technology, including, but not limited to GSM, UMTS, 3GPP LTE, LTE Advanced, WiMAX, etc.

In an embodiment, the backhaul portion of the data communications network 202 may employ any of the following common communications technologies: optical fiber, coaxial cable, twisted pair cable, Ethernet cable, and powerline cable, along with any other wireless communication technology known in the art. In an embodiment, any of the service provider controller devices 204, 206, and 208, the network base stations 210, cellular devices 214, and satellite receivers 218 may include any standard computing software and hardware necessary for processing, storing, and communicating data between each other within the communications system 200. The computing hardware realized by any of the devices of system 200, including any of devices 204, 206, 208, 210, 214, and 208 may include one or more processors, volatile and non-volatile memories, user interfaces, transcoders, modems, wireline and/or wireless communications transceivers, etc.

Further, any of devices of system 200, including any of devices 204, 206, 208, 210, 214, and 218 may include one or more computer readable media encoded with a set of computer readable instructions which, when executed, can perform a portion of various processes associated with embodiments of the present invention. In context with various embodiments of the present invention, it should be understood that wireless communications coverage associated with various data communication technologies (e.g., network base stations 210) typically vary between different service provider networks based on the type of network and the system infrastructure deployed within a particular region of a network (e.g., differences between GSM, UMTS, LTE, LTE Advanced, and WiMAX based networks and the technologies deployed in each network type).

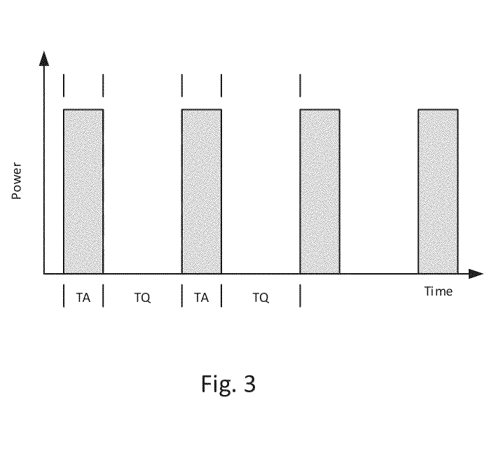

FIG. 3 illustrates an allocation of time slots according to an embodiment of the present invention. Two different time slots are shown in FIG. 3—time slot TA, which corresponds to an active time, and time slot TQ, which corresponds to a quiet time.

In an embodiment, the time slots TA are active transmission times for a plurality of base stations, and time slots TQ are quiet times for the plurality of base stations. In one embodiment, all base stations in a cellular network transmit data during time period TA, and none of the base stations transmit data for time period TQ. During the quiet times TQ, ground based satellite receivers can successfully receive signals from the satellite. While the cellular base stations are transmitting in times TA, the interference levels caused by the cellular base stations may be such that some or all of the ground based satellite receivers will not successfully receive the signals transmitted by the orbiting satellites.

In an embodiment, active transmission time slots of TA FIG. 3 correspond to transmission times for both cellular base stations and cellular devices. In such an embodiment, terrestrial communications occur exclusively during time slots TA, and satellite communications occur exclusively during time slots TQ. In another embodiment, cellular devices may transmit RF signals to a base station during time slots TQ.

Aspects of the transmission timing shown in FIG. 3 are similar to the transmission timing used in cellular networks that use Time Division Duplexing (TDD), where the downlink and uplink transmissions are on the same frequencies, but separated in time. However, in TDD cellular systems, the proportion of time used for downlink transmissions is typically greater than the amount of time used for uplink transmissions. For example, in a typical implementation of a TDD scheme, about 70% of the time is used for downlink transmissions, while 30% of the time is used for uplink transmissions.

In contrast, in an embodiment of the present invention, the proportion of time during which the cellular base stations are transmitting (TA) may be less than proportions of time used in a cellular TDD scheme in order to ensure successful operation of the ground based satellite receivers. Accordingly, embodiments of the present invention may dedicate 50% or more of the time to quiet time TQ, and less than 50% to active transmission times TA. In one embodiment, TQ is 70%, and TA is 30%. Other embodiments may use proportions in which TQ is 90% or more of the total time.

Embodiments of the present invention may be used in conjunction with a TDD scheme. In such an embodiment, times TA may be further divided into a plurality of time slots which are divided between base station transmission times and cellular device transmission times. In another embodiment, the base stations and cellular devices both transmit simultaneously during times TA. In such an embodiment, the cellular devices may transmit on one or more frequency that is different from one or more frequency used for base station transmissions. In another embodiment, TA may be divided between macro cells and pico cells.

A distinction between a TDD scheme and embodiments of the present invention can be explained with respect to FIG. 3. In a TDD scheme, cellular device transmissions occur during base station quiet times. Instead, when embodiments according to the present invention are used with TDD systems, the transmission times TA are times during which base station devices and mobile devices may be transmitting. The quiet times TQ are times during which the base station or cellular devices could be transmitting, but are not. In an embodiment, base stations do not transmit any RF signals at all during quiet times TQ. In another embodiment, base stations do not transmit any RF signals that are within a predetermined range from satellite frequencies during quiet times TQ.

Actual time values for TA and TQ may be in the millisecond range. For example, in an embodiment, TA is 3 ms, and TQ is 7 ms. In another embodiment, quiet times TQ as shown in FIG. 3 may be considerably longer than the times allocated for downlink or uplink transmissions in a typical cellular TDD system. For example, the duration of quiet time TQ may be considerably longer, such as 70 ms, to ensure that certain satellite transmission are received with minimal interference.

In general, longer times for TA improve the performance of the cellular network, while longer quiet times TQ improve the reception of satellite transmissions. Although several specific values have been discussed above, embodiments are not limited to those values; persons of skill in the art will recognize that other values are possible within the scope of the present invention.

The relative timing of the transmission times TA and quiet times TQ of the cellular base stations can be selected so that the ground based satellite receivers still provide acceptable levels of overall performance. For example, in an embodiment which includes a GPS receiver, the quiet times TQ and active transmission times TA of the cellular network may be selected in such a way that the GPS receiver can make sufficiently accurate estimations of where it is located. Various embodiments are possible, in which the amount of base station quiet time TQ may be increased to improve satellite reception, or the amount of base station transmission time TA may be increased to improve cellular communication.

The duration of the transmission times and the quiet times may vary in different embodiments based on the characteristics of the ground based satellite receivers. The durations may be as short as a few microseconds, or as long as several seconds. The cellular network may have benchmarks for providing service to its users, so the quality of service requirements of the services provided by the cellular network may be taken into account in determining the times.

In the description above, quiet times TQ are described as times during which no transmissions take place. However, embodiments may use multiple transmission powers, including at least a high power level and a low power level. An example of a system which employs multiple power levels can be found in U.S. application Ser. No. 13/856,416, which is incorporated herein by reference. Accordingly, in an embodiment of the present invention, acceptable performance of the ground based satellite terminals may be achieved if low power signals are transmitted by the base station network during the quiet times TQ. In such an embodiment, performance may be enhanced by selecting a frequency for low power transmissions which is further from satellite frequencies than frequencies used for high power transmissions.

In addition, the timing scheme of FIG. 3 can be applied to various frequency arrangements in various embodiments. For example, an embodiment can be applied to adjacent frequencies, where frequencies used for terrestrial cellular transmissions are adjacent to frequencies used for satellite transmissions. In such an embodiment, the present invention can reduce or eliminate the need for a guard band, increasing the efficiency of frequency usage. In another embodiment, frequencies can be shared between satellite and terrestrial communications, where satellite and terrestrial transmissions occur in overlapping frequencies. In other words, in an embodiment, satellite transmissions and terrestrial cellular transmissions occur on the same frequency band.

In some situations, ground based satellite devices may only receive problematic levels of interference from a single base station or base station antenna. In such cases, acceptable performance may be achieved without using quiet times in which all cellular base stations cease transmissions. Some embodiments may use one or more aspect of a time reuse scheme.

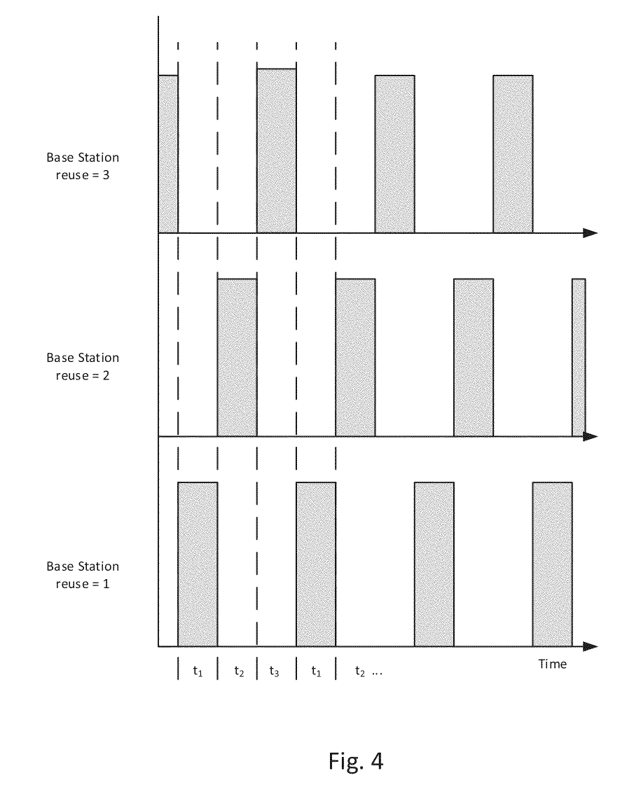

FIG. 4 shows an example of a time reuse of 3 for base station transmissions. Base stations configured with time reuse pattern equal to 1 have transmission times during t₁ and quiet times during t₂ and t₃. Base stations configured with time reuse pattern equal to 2 have transmission times during t₂ and quiet times during t₁ and t₃. Base stations configured with time reuse pattern equal to 3 have transmission times during t₃ and quiet times during t₁ and t₂.

In an embodiment that is integrated with a time reuse scheme such as the scheme illustrated by FIG. 4, the ground based satellite devices may achieve the same performance as when the cellular base stations use the timing for transmission times and quiet times as shown in FIG. 3. However, the cellular network benefits from the time reuse of the transmission and quiet times, as mobile devices in the network experience reduced levels of interference from neighbor (non-serving) base stations in an embodiment in which the base stations operate on a common channel allocation. According to an embodiment of the present invention, time slots may be divided between various portions of macro cells.

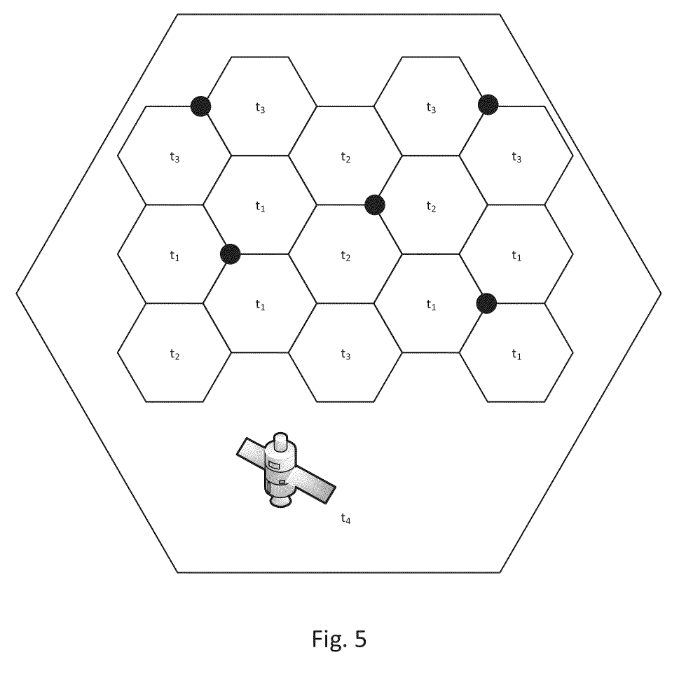

For base stations site with multiple sectors, the time reuse pattern may be applied in at least two ways. In a first way, which is illustrated in FIG. 5, all of the cells of a base station are assigned the same time reuse pattern. FIG. 5 shows a plurality of base stations, which are represented by dark circles. Each base station has three antennas which serve three cells, depicted by the three hexagons in contact with each base station. As seen in FIG. 5, each base station transmits during a time t₁, t₂, or t₃, which correspond to the times in FIG. 4.

FIG. 5 shows a time reuse of 4, which includes time slot t₄. In an embodiment, a time slot may be assigned during which all terrestrial communications are silent. For example, in the reuse scheme shown in FIG. 5, sets of base stations transmit during time slots t₁-t₃, and are silent during time slot t₄. In such an embodiment, satellite transmissions can be received by satellite receivers free of interference during time t₄.

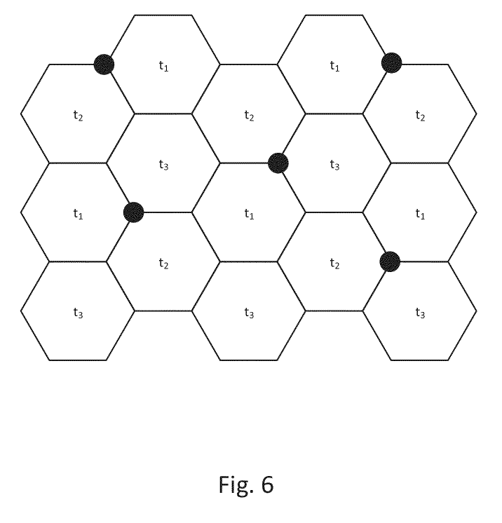

In a second way, as shown in FIG. 6, each cell at a base station site is assigned a different time reuse pattern. Using the time reuse of 3 shown in FIG. 6, no two adjacent cells are transmitting at the same time. Although FIGS. 3-6 each show embodiments with time reuse of 3 and 4, embodiments of the present invention are not limited to these values. Other embodiments may use a reuse of 2, 5, 6, etc.

The first way of assigning the time reuse pattern (FIG. 5) may result in poorer performance for the cellular network than the second way (FIG. 6). However, the first way of assigning time reuse may provide for better performance of the ground based satellite terminals, as the ground based satellite terminals are more likely to receive problematic levels of interference from two sectors of the same base station than they are to receive problematic levels of interference from two geographically separated base station sites. Accordingly, embodiments of the present invention may employ either scheme.

In some embodiments, transmission frequencies may be used to determine certain aspects of a time distribution scheme. For example, cellular devices may transmit on a frequency that is further from satellite frequencies than the base station transmission frequency. In such an embodiment, the combination of the lower transmission power of the cellular devices and the further frequency separation may achieve acceptable performance for both terrestrial and satellite communications even when cellular devices are transmitting during all of the time slots.

In another embodiment, cellular device transmissions are assigned to frequencies which are closer to satellite transmissions than the base station transmission frequencies. Such an embodiment is more likely to be combined with a transmission scheme in which base station transmissions and cellular device transmissions share transmission and quiet times. Assigning terrestrial frequencies to cellular devices that are closer to satellite frequencies than frequencies assigned to base station transmissions may reduce levels of interference experienced by satellite receivers.

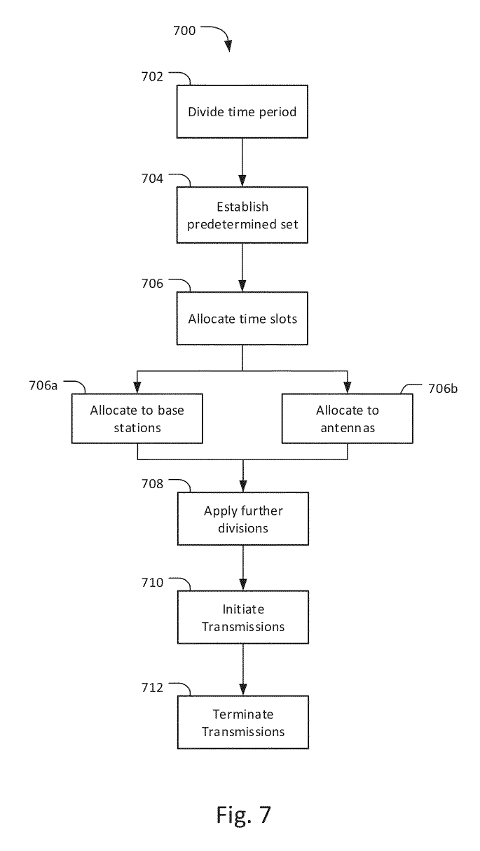

FIG. 7 illustrates a method 700 for cellular communications in frequencies adjacent to or overlapping with satellite communication frequencies. In an embodiment, a method 700 includes a process 702 of dividing a time period. In an embodiment, a time period is a duration of time in which a full cycle of time slots occurs. For example, if there are only two repeating time slots, then a time period is the sum of the times of the two time slots. A time period may be divided into two time slots, as shown in FIG. 3, three time slots as shown in FIG. 4, or a larger number of time slots.

The process 702 of dividing a time period may be applied to various frequencies. In general, the time period is applied to terrestrial cellular frequencies which are adjacent, or nearly adjacent, to frequencies used for satellite transmissions. In an embodiment, the process of dividing a time period can be applied to terrestrial cellular transmissions that overlap with frequencies that are used for satellite transmissions, so that terrestrial cellular communications can coexist with satellite communications within the same frequency range.

In some embodiments, a limited number of ground based satellite receivers may be receiving interference from cellular base stations. In such embodiments, cellular system performance may be preserved by only applying time divisions to base stations causing the interference. Accordingly, in some embodiments, a process 704 establishes a predetermined set of base stations, or base station antennas, to which the divided time period is applied. Embodiments of process 704 will now be explained with respect to a satellite receiver 800.

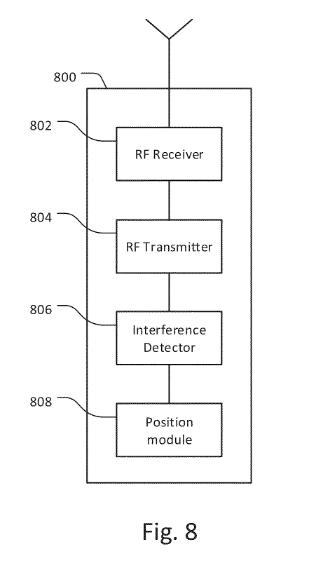

FIG. 8 shows an embodiment of a satellite receiver 800. A satellite receiver includes an RF receiver 802 for receiving RF satellite transmissions, and may also include an RF transmitter 804, an interference detector 806, and a position module 808. In an embodiment, when interference detector 806 detects RF interference, a signal is transmitted from RF transmitter 804 to a cellular base station. The signal may include position information related to the position of satellite receiver 800 which is determined by position module 808.

When a base station receives a signal indicating that satellite receiver 800 is receiving interference from cellular base station communications, the base station, or one or more network equipment such as a network resource controller may identify the set of base stations, or base station antennas, to which a time division scheme will be applied. In an embodiment, the set includes all base stations or base station antennas which are transmitting interfering frequencies within a predetermined distance from satellite receiver 800. This determination may include position information from position module 808, or the position of one or more base station which received the signal from receiver 800.

In other embodiments, establishing a predetermined set of base stations 704 may be performed without satellite receivers 800 transmitting signals directly to base stations. For example, in one embodiment, a satellite receiver 800 may transmit position information to a satellite. In another embodiment, a predetermined area may be identified by a manual process. For example, situations may arise in which it is important for military or emergency personnel to receive satellite communications with reduced levels of interference without shutting down a terrestrial cellular network. In such a case, a technician may select a predetermined area in which time divisions will be applied to cellular base stations.

Another possible consideration in a process 704 of establishing a predetermined set of base stations or base station antennas is the RF frequencies which are transmitted by the base stations or antennas. In an embodiment, process 704 may include determining a set of base stations or antennas which transmit on frequencies that interfere with satellite transmissions. In embodiments, the interfering frequencies may be cellular frequencies which are adjacent to or overlap with satellite transmission frequencies.

In an embodiment, once it is understood that periodic high levels of interference may be seen by the ground based satellite receivers, the design of those receivers may be modified so that they can continue to operate in the presence of such interference. One example is where satellite receiver 800 is a GPS receiver which includes interference detector 806. In a GPS receiver, the position determination is made by position module 808 upon reception of signals from the GPS satellite constellation. It is common in some applications (e.g., military applications where jamming is anticipated) to include an interference detector 806. When interference is detected, the received signal is not passed to the position module 808. In such an embodiment, the position determination is made using received signals that have no interference or acceptably low levels of interference.

Returning to FIG. 7, method 700 further includes a process 706 of allocating time slots to network equipment. In an embodiment such as the embodiment of FIG. 5 in which time slots are divided by base station, process 706 may include a process 706a of allocating time slots to base stations. In an embodiment such as the embodiment of FIG. 6 in which time slots are divided by antenna, process 706 may include a process 706b of allocating time slots to antennas.

In some embodiments, method 700 includes a process 708 of applying further time divisions to time slots. For example, consider an embodiment according to FIG. 3, in which a time period is divided into an active transmission time TA in which terrestrial cellular transmissions occur, and a quiet time TQ in which terrestrial cellular equipment do not transmit RF signals in an interfering frequency range. In such an embodiment, process 708 may include applying time divisions according to a TDD scheme to divide transmission between a macro cell and a pico cell, between base stations and cellular devices, etc. The time divisions applied in 708 may be in accordance with a cellular communications standard such as LTE.

In process 710, each base station or antenna to which time slots have been allocated in process 706 initiates RF transmissions at the start of a time slot. Next, when the time slot ends, in process 712 the antenna or base station terminates transmissions. Accordingly, the antenna or base station does not transmit RF signals which interfere with satellite transmissions for a next time slot. The antenna or base station performs process 710 at the start of each active time slot that is allocated to it, and performs process 712 at the end of the allocated active time slot.

The above considerations may be applied to existing cellular networks and satellite networks via testing of the ground based satellite devices to determine appropriate values for any of the time slots. In some embodiments, it may not be possible to determine such appropriate values that allow both the cellular and satellite networks to continue to provide acceptable levels of service.

In some embodiments, it may be necessary to modify the protocols used by one or both of the satellite or terrestrial networks. For example, some cellular networks are configured to transmit base station signals such as a reference signal at periodic intervals even when a base station is not transmitting data, and cellular devices attached to such a base station may be affected by the lack of a reference signal. In this example, protocols may be modified to ensure that no radio transmissions are made by the base stations during quiet times, and that cellular devices function normally when reference signal transmissions are interrupted. Alternatively, if it is not feasible to modify the network protocols (e.g., because there is already a substantial amount of legacy equipment deployed), new network deployments may be possible via appropriate protocol modifications.

While several embodiments of the present invention have been illustrated and described herein, changes can be made without departing from the spirit and scope of the invention. Accordingly, the scope of the invention is not limited by any disclosed embodiment. Instead, the scope of the invention should be determined from the appended claims that follow.

What is claimed is:

1. A system for coordinating terrestrial and satellite radio frequency (RF) communications, the system comprising:
a processor; and
a non-transient computer readable medium with computer executable instructions stored thereon which, when executed by the processor, performs the following steps:
dividing a predetermined time period into a plurality of time slots;
designating a first time slot from among the plurality of divided time slots as an active communication time for at least one antenna of a first base station;
designating a second time slot from among the plurality of divided time slots as a silent time for the least one antenna of the first base station;
initiating RF transmissions from the at least one antenna of the first base station, cellular devices attached to the at least one antenna of the first base station, or a combination thereof during the first time slot; and
terminating the RF transmissions from the at least one antenna of the first base station, cellular devices attached to the at least one antenna of the first base station, or a combination thereof prior to the start of the second time slot,
wherein the at least one antenna of the first base station does not transmit RF signals for the duration of the second time slot.

2. The system of claim 1, wherein a portion of the RF spectrum used for the transmissions from the at least one antenna of the first base station is adjacent to a portion of the RF spectrum allocated for satellite transmissions.

3. The system of claim 1, wherein a portion of the RF spectrum used for the transmissions from the at least one antenna of the first base station overlaps with a portion of the RF spectrum allocated for satellite transmissions.

4. The system of claim 1, wherein the predetermined time period is divided into a plurality of the first time slots and a plurality of the second time slots, each of the first time slots alternating with each of the second time slots.

5. The system of claim 4, wherein each of the first time slots is divided into at least one third time slot and at least one fourth time slot according to a time division duplexing (TDD) scheme.

6. The system of claim 1, wherein the non-transient computer readable medium with computer executable instructions stored thereon which, when executed by the processor, performs the following additional steps:
designating a third time slot from among the plurality of divided time slots, the first, second, and third time slots occurring in consecutive order;
allocating the first time slot to a first antenna attached to the first base station;
allocating the second time slot to a second antenna attached to the first base station; and
allocating the third time slot to a third antenna attached to the first base station;
wherein each of first, second, and third antennas transmit RF signals during the time slots to which they are allocated, and do not transmit RF signals during the time slots to which they are not allocated.

7. The system of claim 1, wherein the non-transient computer readable medium with computer executable instructions stored thereon which, when executed by the processor, performs the following additional steps:
designating a third time slot from among the plurality of divided time slots, the first, second, and third time slots occurring in consecutive order;
allocating the first time slot to the first base station;
allocating the second time slot to a second base station; and
allocating the third time slot to a third base station;
wherein each of first, second, and third base stations transmit RF signals during the time slots to which they are allocated, and do not transmit RF signals during the time slots to which they are not allocated.

8. The system of claim 1, wherein each of a predetermined set of antennas ceases RF transmissions for the duration of the second time slot.

9. The system of claim 8, wherein the predetermined set of antennas is selected based on a relationship between the predetermined set of antennas and a ground-based satellite receiver.

10. A method for coordination of terrestrial and satellite based communications, comprising:
dividing a predetermined time period into a plurality of time slots;
designating a first time slot from among the plurality of divided time slots as an active communication time for at least one antenna of a first base station;
designating a second time slot from among the plurality of divided time slots as a silent time for the least one antenna of the first base station;
initiating RF transmissions from the at least one antenna of the first base station, cellular devices attached to the at least one antenna of the first base station, or a combination thereof at the start of the first time slot; and
terminating the RF transmissions from the at least one antenna of the first base station, cellular devices attached to the at least one antenna of the first base station, or a combination thereof at the start of the second time slot,
wherein the at least one antenna of the first base station does not transmit RF signals for the duration of the second time slot.

11. The method of claim 10, wherein a portion of the RF spectrum used for the transmissions from the at least one antenna of the first base station is adjacent to a portion of the RF spectrum allocated for satellite transmissions.

12. The method of claim 10, wherein a portion of the RF spectrum used for the transmissions from the at least one antenna of the first base station overlaps with a portion of the RF spectrum allocated for satellite transmissions.

13. The method of claim 10, wherein the predetermined time period is divided into a plurality of the first time slots and a plurality of the second time slots, each of the first time slots alternating with each of the second time slots.

14. The method of claim 13, wherein each of the first time slots is divided into at least one third time slot and at least one fourth time slot according to a time division duplexing (TDD) scheme.

15. The method of claim 10, further comprising:
designating a third time slot from among the plurality of divided time slots, the first, second, and third time slots occurring in consecutive order;
allocating the first time slot to a first antenna attached to the first base station;
allocating the second time slot to a second antenna attached to the first base station; and
allocating the third time slot to a third antenna attached to the first base station;
wherein each of first, second, and third antennas transmit RF signals during the time slots to which they are allocated, and do not transmit RF signals during the time slots to which they are not allocated.

16. The method of claim 10, further comprising:
designating a third time slot from among the plurality of divided time slots, the first, second, and third time slots occurring in consecutive order;
allocating the first time slot to the first base station;
allocating the second time slot to a second base station; and
allocating the third time slot to a third base station;
wherein each of first, second, and third base stations transmit RF signals during the time slots to which they are allocated, and do not transmit RF signals during the time slots to which they are not allocated.

17. The method of claim 10, wherein each of a predetermined set of antennas ceases RF transmissions for the duration of the second time slot.

18. The method of claim 17, wherein the predetermined set of antennas is selected based on a relationship between the predetermined set of antennas and a ground-based satellite receiver.

19. A system for coordinating terrestrial and satellite radio frequency (RF) communications, the system comprising:
a processor; and
a non-transient computer readable medium with computer executable instructions stored thereon which, when executed by the processor, performs the following steps:
dividing a predetermined time period into a plurality of time slots;
designating a first time slot from among the plurality of divided time slots as an active communication time for at least one antenna of a first base station;
designating a second time slot from among the plurality of divided time slots as a silent time for the at least one antenna of the first base station;
initiating RF transmissions from the at least one antenna of the first base station, cellular devices attached to the at least one antenna of the first base station, or a combination thereof at the start of the first time slot; and
terminating the RF transmissions from the at least one antenna of the first base station, cellular devices attached to the at least one antenna of the first base station, or a combination thereof at prior to the start of the second time slot,
wherein the at least one antenna of the first base station does not transmit high power RF signals for the duration of the first time slot.

20. The system of claim 19, wherein a portion of the RF spectrum used for the transmissions from the at least one antenna of the first base station is adjacent to a portion of the RF spectrum allocated for satellite transmissions.
